(19) United States
(12) Patent Application Publication
(10) Pub. No.: US 2004/0220996 A1
(43) Pub. Date: Nov. 4, 2004

(54) Multi-platform computer network and method of simplifying access to the multi-platform computer network

(75) Inventors: Chien-Chung Huang, Hsin-Chu City (TW); Gean-Weijeffrey Liou, Hsin-Chu City (TW); Tien-Der Chiang, Da-Li City (TW); Chun-Yi Chen, Hualion (TW); Wen-Chang Kuo, Hsin-Chu City (TW)

Correspondence Address: TUNG & ASSOCIATES, Suite 120, 838 W. Long Lake Road, Bloomfield Hills, MI, 48302, US

(73) Assignee: Taiwan Semiconductor Manufaturing Co., Ltd.

(21) Appl. No.: 10/425,204

(22) Filed: Apr. 29, 2003

(51) Int. Cl. G06F 15/16

(52) U.S. Cl. 709/201

(57) ABSTRACT

The present invention provides a multiple platform computer network having: at least one client device; a main service platform, the main service platform in selective communication with the client device when the client device is properly authenticated and authorized for use with the main service platform; a support platform for providing support to the main service platform; a dummy log-in user interface for interfacing between the main service platform and the at least one client device; and a control handling system for handling communications between the main service platform and the support platform. Optionally, a content ID mapping table capable of associating each of a plurality of support platform user numbers with content accessible within the support platform is provided. Two methods of using a multiple platform computer network to simplify access to the network and to reduce licensing fees associated with user access is provided herewithin.

### FIELD OF THE INVENTION

The present invention relates to a multi-platform computer network and a method of simplifying access to the multi-platform computer network.

### BACKGROUND

Many information technology (IT) systems are disposed within different platforms to save time, costs, provide integration and enhance performance. However, IT systems disposed within different platforms must be integrated/re-integrated with other platforms in accordance with a system user's needs.

In a business to employee platform, an employee portal (EP) is provided as a single entrance point to provide employees enterprise information or services. However portions of each IT system are developed in chronologically different stages. Infrequent of occasional users of only specific portions of each IT system must log-in to the employee portal to access a specific portion of an IT system.

Providing access to such occasional users can be costly. For example, some software applications and services disposed within different platforms are bundled together in order to provide a single portal or a single access point and to save development and operation costs. Management of account usage may prove problematic when users must log into a main platform A in communication with a supporting platform B to access applications disposed within the supporting platform B, wherein platform A is in direct communication with a client device to directly provide support or service to a user. A user needs user accounts for platform A in order to log-in to the IT system to perform desired activities.

In order to launch the applications or services disposed within platform B, a user must first have an account for platform A in order to access/log-into platform A, and then another account for platform B to access services disposed within platform B. Licensing fees associated with each account within each platform A and B are also required. While actual usage of platform A is typically minimal, the licensing fees associated with each user account having access to platform A equals the cost of licensing fees paid for access to platform B, where the usage of accounts is the greatest. Therefore it is desirable to reduce licensing fees associated with accessing platform A an IT system.

Another way of accessing platform B is to provide another service system such as a platform, a web service, a security control, or an application program service. However an additional service system complicates rather than simplifies an account user's experience/access. Provide a plurality of portals to access an associated plurality of platforms.

Typically, licensing fees associated with each platform such as an NT platform average $800.00 per user. Thus, licensing fees associated with a large enterprise having thousands of users can prove costly.

It is desirable to provide a system that simplifies a system user's experience.

### SUMMARY OF THE INVENTION

The present invention operates to avoid high IT system development costs and associated maintenance costs.

In general, the present invention provides a single access user interface (a dummy user log-in user interface) to access a main service platform using a dummy user-ID and dummy account and further provides a content ID mapping table to map a user number with accessible content available within a support platform. The dummy user log-in user interface essentially eliminates the need for a separate account and associated user ID for each actual user accessing the main platform because access to the main service platform may be performed using a single “dummy” account or relatively few accounts available to a plurality of users. The actual license fees and number of actual users licensed to use the dummy account using the dummy user log-in user interface may vary in accordance with an agreement between a specific company providing the multiple platform computer network and associated software or application programs, and an entity actually using the multiple platform computer network. However, because fewer accounts are required by having a common user, less licensing fees should be paid by the entity actually using the multiple platform computer network.

In accordance with one embodiment of the present invention, the present invention provides a multiple platform computer network having:

at least one client device;

a main service platform, the main service platform in selective communication with the client device when the client device is properly authenticated and authorized for use with the main service platform;

a support platform for providing support to the main service platform;

a dummy log-in user interface for interfacing between the main service platform and the at least one client device; and

a control handling system for handling communications between the main service platform and the support platform.

In accordance with another preferred embodiment of the present invention, the present invention provides a multiple platform computer network comprising a:

at least one client device;

a main service platform, the main service platform in selective communication with the client device when the client device is properly authenticated and authorized for use with the main service platform;

a support platform for providing support to the main service platform;

a dummy user log-in user interface for interfacing between the main service platform and the at least one client device;

a content ID mapping table capable of associating each of a plurality of support platform user numbers with content accessible within the support platform; and

a control handling system for handling communications between the main service platform and the support platform.

Two methods of use are also provided in accordance with two embodiments of the present invention.

The first preferred method provides a method for simplifying access to a multiple platform multiple platform computer network, the method having the steps of:

a) providing a main service platform, wherein the main service platform has at least one access point server and an associated main service platform database in communication with the at least one access point server;

b) providing a support platform to support the main service platform, wherein the support platform has a support platform server and an associated support platform database in operative communication with the support platform server, the support platform in further operative communication with the main service platform;

c) creating a dummy user log-in account on the main service platform, wherein the dummy user log-in account has an associated dummy user identification representing a common user;

d) creating a dummy user log-in user interface for accessing the dummy user log-in account on the main service platform; and

e) providing a control handling system to handle communications between the main service platform and the support platform.

Additionally, the second preferred method in accordance with a preferred embodiment of the present invention provides a method of using a multi-platform computer network comprising the steps of:

providing at least one client device;

providing a main service platform, wherein the main service platform has at least one access point server and an associated main service platform database in communication with the at least one access point server, wherein the at main service platform is in operative communication with the at least one client device;

providing a support platform to support the main service platform, wherein the support platform has a support platform server and an associated support platform database in operative communication with the support platform server, the support platform in further operative communication with the main service platform;

creating a dummy user log-in account on the main service platform, wherein the dummy user log-in account has an associated dummy user identification representing a common user;

creating a dummy user log-in user interface for accessing the dummy user log-in account on the main service platform; and

using a control handling system to authenticate and to authorize a user access to permitted applications and data disposed within the support platform in accordance with the content ID mapping table disposed within the main service platform.

### BRIEF DESCRIPTION OF THE DRAWINGS

These and other objects, features and advantages of the present invention will become apparent from the following detailed description and the appended drawings in which:

FIG. 1 is an overview of a multi-platform computer network in accordance with the present invention.

FIG. 2 is a graphical illustration of contents of a main service platform database in accordance with the present invention.

FIG. 3 is a flowchart showing a method for simplifying access to a multiple platform multiple platform computer network in accordance with the present invention.

FIG. 4 is a flowchart showing of a method of using a multi-platform computer network in accordance with the present invention.

### DETAILED DESCRIPTION OF THE PREFERRED EMBODIMENTS

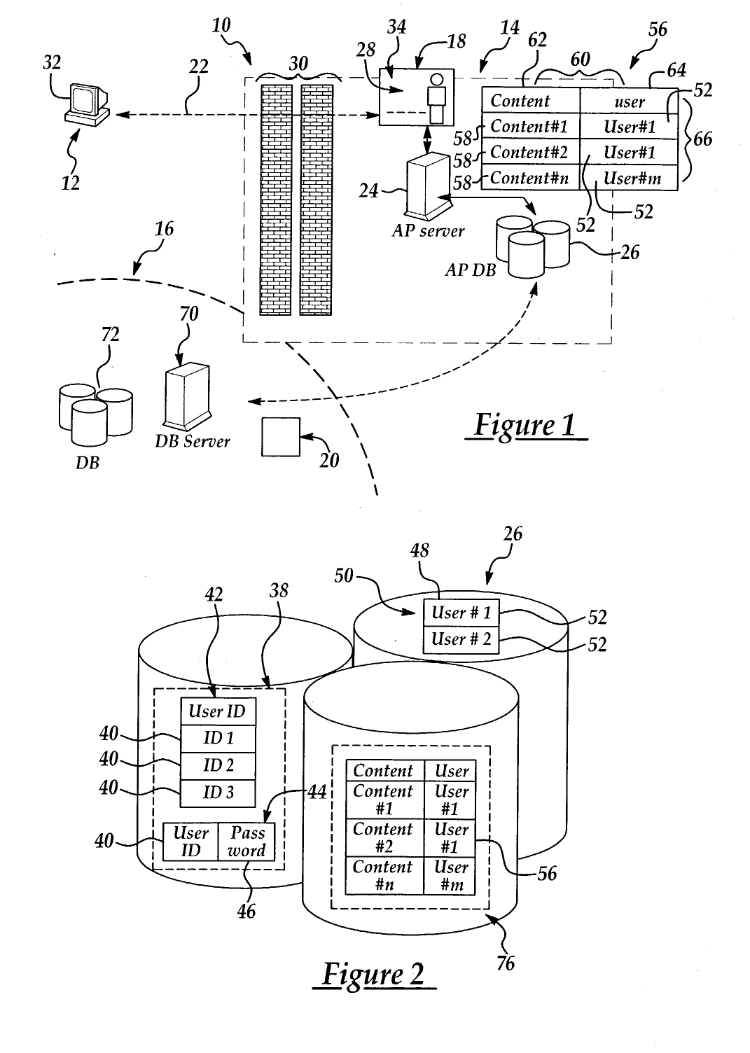

Referring now to the drawings, as shown in FIG. 1, the present invention provides a multiple platform computer network 10 having:

at least one client device 12;

a main service platform 14, the main service platform 14 in selective communication with the client device 12 when the client device 12 is properly authenticated and authorized for use with the main service platform 14;

a support platform 16 for providing support to the main service platform 14;

a dummy user log-in user interface 18 for interfacing between the main service platform 14 and the at least one client device 12; and

a control handling system 20 for handling communications between the main service platform 14 and the support platform 16.

Optionally, the at least one client device 12 may have a viewing screen 32 for viewing a configurable browser. Also, optionally, multiple platform computer network 10 may have a plurality of client devices 14 (not shown) in communication with the main service platform 14.

Additionally, the multiple platform computer network 10 preferably has a communication conduit 22 for communicating between the main service platform 14 and the client device 12. The communication conduit 22 for communicating between the client device 12 and the main service platform 14 can be in the form of standard Ethernet cables, employing, for example, WideBand 800 Mbs technology, between wired networks such as a LAN or WAN. Additionally, a Virtual Private Network having the at least one client device 12 in communication with the main service platform 14 may be used to access the multiple platform computer network 10. Additionally, where the client device 12 is a Personal Digital Assistant, a cell-phone, or a VPN of PDA's and cell-phones, the client device may connect to the main service platform 14 preferably using Wireless Application Protocol (“WAP”).

The main service platform 14 has at least one access point (AP) server 24 and at least one access point (AP) database (DB) 26, wherein the at least one AP server 24 is in communication with the AP DB 26, and is in further communication with the at least one client device 12.

Optionally, the main service platform 14 may further have a session server 16 (not shown) for monitoring and logging activities occurring within the multiple platform computer network 10.

The support platform 16, preferably has at least one support platform server 70 and at least one support platform database 72 in operative communication with each other. Also, preferably the at least one support platform server 70 is in operative communication with the main service platform 14. The at least one support platform server 70 may be selected from a group of an application server, a groupware server, a fax server, a ftp server, an audio/video server, a chat server, an IRC servers, a list server, a mail server, a news server, and a web server, however, the platform server list should not be listed to only the listed servers but may be any server suitable to communicate within the multiple platform computer network 10, preferably within a large enterprise entity.

The dummy log-in user interface 18 operates as a single employee or user portal for access to the main service platform. Preferably, the dummy user log-in user interface 18 has a configurable browser 34 that may displayed within the viewing screen 32 disposed within the at least one client device 12. The dummy user log-in user interface 18 essentially eliminates the need for a separate account and associated user ID for each actual user accessing the main platform because access to the main service platform may be performed using a single “dummy” account or relatively few accounts available to a plurality of users. The single account has an associated ID that may accessed by a common or “dummy” user on the main service platform 14. The actual license fees and number of actual users licensed to use the dummy account using the dummy user log-in user interface 18 may vary in accordance with an agreement between a specific company providing the multiple platform computer network and associated software or application programs, and an entity actually using the multiple platform computer network 10. However, because fewer accounts are required by having a common user, less licensing fees should be paid by the entity actually using the multiple platform computer network 10.

Preferably, the dummy log-in user interface has a dummy account-password program 28 disposed within the dummy log-in user interface 18 for creating the dummy account to log into the main service platform 14, wherein the dummy account has an associated dummy user log-in ID for logging into to the main service platform 14.

In a preferred embodiment, the dummy account-password program 28 may be manually executed by a user of the at least one client device 12 in communication with the dummy user log-in user interface 18, preferably by having a user enter a dummy log-in ID and associated dummy password into the configurable browser disposed within the dummy user log-in user interface 18.

However, preferably, in another preferred embodiment, the dummy account-password program 28 is a script that is automatically executed upon activation of the client device 12 in selective communication with the main service platform 14. The execution of the script having the dummy ID and associated password is transparent to a user of the client device 12.

Additionally, the multiple platform computer network 10 preferably provides a security layer 30 that cooperates with the dummy user log-in user interface 18 for securing access to both the main service platform 14 and to the support platform 16. The security layer 30 prevents an unauthorized user from accessing the multiple platform computer network. The security layer 30 may have a firewall that filters communications from devices outside the server network or a security authentification program that filters communication from unauthorized users within the server network.

Optionally, a server having built-in firewall protection such as a Microsoft® Internet Security and Acceleration server may provide secure access to the multiple platform computer network 10. Alternatively, a firewall such as the Novell BorderManager™ may be employed to prevent unauthorized users from accessing the multiple platform computer network.

Alternatively, the firewall system may be a single firewall server or may used in combination with firewall server systems such as IBM eServer on an open source operating system such as OpenLinux owned by the Caldera Corporation as is well known in the information technology arts, wherein the open source system cooperates with the dummy user log-in user interface 18 to allow an automated dummy script in combination with the open source system to be used to authenticate and authorize a user.

However, any suitable type of firewall system may be used alone or in combination with a security authentication and authorization system 36 may be used to prevent any security breeches in the multiple platform computer network.

Optionally, the security layer 30 for securing access to the multiple platform computer network 10 may employ a security authentication and authorization system 36 having a security directory such as a Novell E-Directory or a Microsoft Active Directory which is part of an x.500 Directory in combination with the dummy user log-in user interface 18 to allow a manually executed dummy account password program or an automated dummy script to first authenticate a user and then verify authorization of the user to access the main service platform.

As shown in FIG. 1, the support platform 16 may be accessed through the at least one client device 12 by initially logging into the main service platform 14 via the dummy user log-in UI 18, and then by entering secure information such as a non-dummy user name and a non-dummy password associated with a specified user into the configurable browser using a security menu (not shown) disposed within the optional viewing screen of client device 12. However, authorizing a user to access the support platform 16 may be performed automatically by using a content ID mapping table in combination with the security layer 30 as described in more detail below.

In accordance with a preferred embodiment of the present invention, as shown in FIG. 2, preferably, the multiple platform computer network 10 has a first memory location 38 structured for storing a plurality of support platform user IDs 40 in an ID table 42, wherein each support platform user ID 40 is associated with at least one client device 12; and an ID mapping table 44 for mapping each of the stored plurality of user IDs 40 with an associated support platform user password 46. Preferably, the first memory location 38 is disposed within the AP database 26 of the main service platform 14.

The plurality of IDs 40 are maintained in accordance with an ID maintenance function performed using the main service platform AP server 26, wherein the ID maintenance function performs maintenance operations selected from at least one of a support platform user ID creation function that operates to associate a support platform user ID with a client device, an update support platform user ID function that operates to modify a support platform user ID in accordance with an authorized system administrator's request or in accordance with an authorized user's request, and a remove support platform user ID function that operates to remove a support platform user ID from the ID table.

Preferably, as shown in FIGS. 1 and 2, the multiple platform computer network 10 additionally has a support platform user number (hereinafter “#”) table 48 disposed within a second memory location 50, preferably disposed within the main service platform AP database 26. The second memory location 50 is structured for insertion of a plurality of support platform user #s 52, wherein each of the plurality of support platform user numbers (hereinafter “#s”) 52 identifies one of the plurality of support platform user identifications (IDs) 40 associated with a support platform user password 46 into a plurality of cells 54 disposed within the support platform user # table 48.

The support platform 16 cooperates with the main service platform 14 to perform an ID mapping function that operates to form a content ID mapping table 56 within a third memory location 76, preferably disposed within the AP DB. The content ID mapping table 56 maps the plurality of support platform user #s 52 disposed within the support platform user # table 48 with at least one associated content 58 associated with each one of the plurality of support platform user #s 52 accessible within the support platform 16.

As shown in FIG. 2, the content ID mapping table 56 has a plurality of cells 60 forming a first column 62, and a second column 64, and a plurality of associated rows 66. The number of the plurality of associated rows 66 having an n total number of content associated with an m number of user #s. The first column 62 specifies permissible content for each support platform user #52, and the second column 64 specifies the user #52 associated with permissible content.

As shown in FIGS. 1 and 2 showing a preferred embodiment of the present invention, the content ID mapping table 56 associates content #1 with a user #1, additionally, the content ID mapping table 56 associates content #2 with the user #1. Similarly, content #n is associated with user #m.

The content ID mapping table 56 acts as a permissions table for granting access to the support platform 16 in accordance with permissions for assessing allowable support platform content associated with each support platform user #52.

Preferably, the control handling system 20 of the multiple platform computer network 10 is preferably a security system that performs an authentication and authorization function preferably using the support platform server. Preferably, the support platform server 70 performs an authentication process for determining who a user is and then performs an authorization process to authorize an authenticated user access to permitted applications and data disposed within the support platform 16 in accordance with the content ID mapping table 56 disposed within the main service platform 14. However, the control handling system 20 may be capable of handling and facilitating any communications between the main service platform 14 and the support platform 16, wherein any communications is not limited authentication and authorization communications. Additionally the control handling system 20 may use any suitable communication technology in accordance with the present invention to share support platform data and support platform content with the main service platform 14.

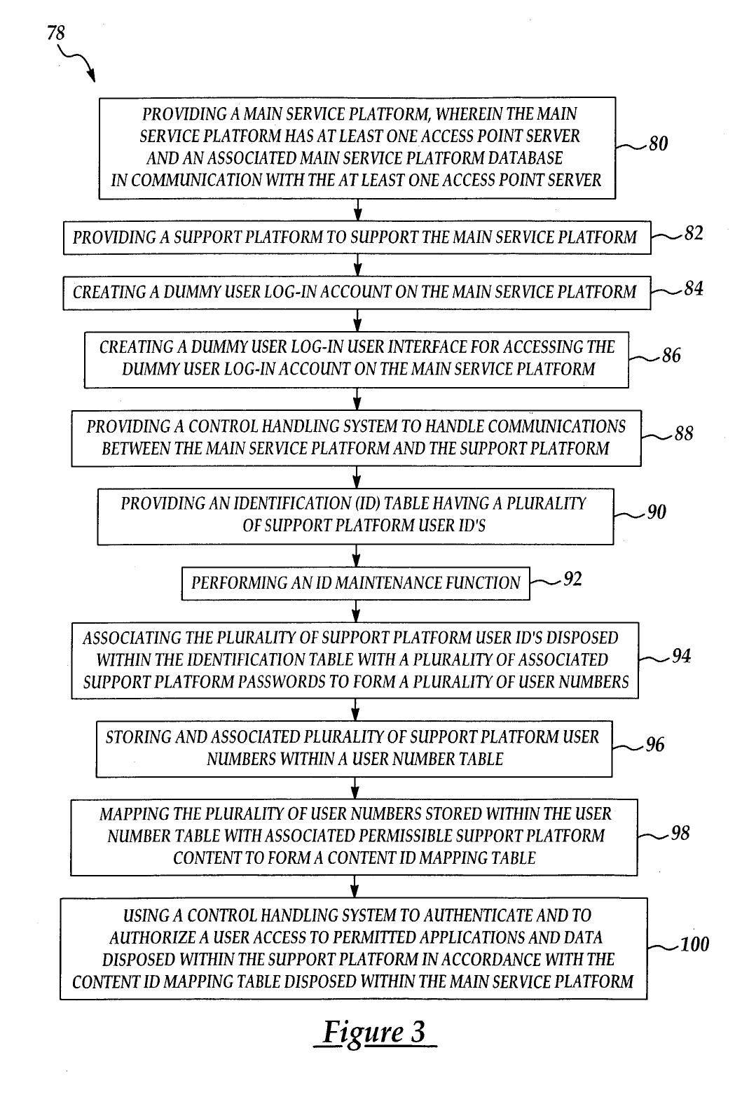

As shown in a method flowchart in FIG. 3, a preferred embodiment of a method 78 for simplifying access to a multiple platform computer network is provided. The method having the steps of:

providing a main service platform, wherein the main service platform has at least one access point server and an associated main service platform database in communication with the at least one access point server (step 80 )

providing a support platform to support the main service platform (step 82 ), wherein the support platform has a support platform server and an associated support platform database in operative communication with the support platform server, the support platform in further operative communication with the main service platform;

creating a dummy user log-in account on the main service platform (step 84), wherein the dummy user log-in account has an associated dummy user identification representing a common user;

creating a dummy user log-in user interface for accessing the dummy user log-in account on the main service platform (step 86); and

providing a control handling system to handle communications between the main service platform and the support platform (step 88).

In another preferred embodiment, the method 78 preferably has the additional steps of:

providing an identification (ID) table having a plurality of support platform user IDs (step 90); and

performing an ID maintenance function (step 92), wherein the ID maintenance function is selected from at least one of a support platform user ID creation function that operates to associate a support platform user ID with a client device, an update support platform user ID function that operates to modify a support platform user ID in accordance with an authorized system user's request, and a remove support platform user ID function that operates to remove a support platform user ID from the ID table.

Preferably, the method 78 further has the steps of:

associating the plurality of support platform user IDs disposed within the identification table with a plurality of associated support platform passwords to form a plurality of user numbers (step 94); and

storing the associated plurality of support platform user numbers within a user number table (step 96);

mapping the plurality of user numbers stored within the user number table with associated permissible support platform content to form a content ID mapping table (step 98), wherein the content ID mapping table disposed within the main platform for associating permissible support platform content with a user number, and wherein the user number associates a user identification with an associated password.

using a control handling system to authenticate and to authorize a user access to permitted applications and data disposed within the support platform in accordance with the content ID mapping table disposed within the main service platform (step 100).

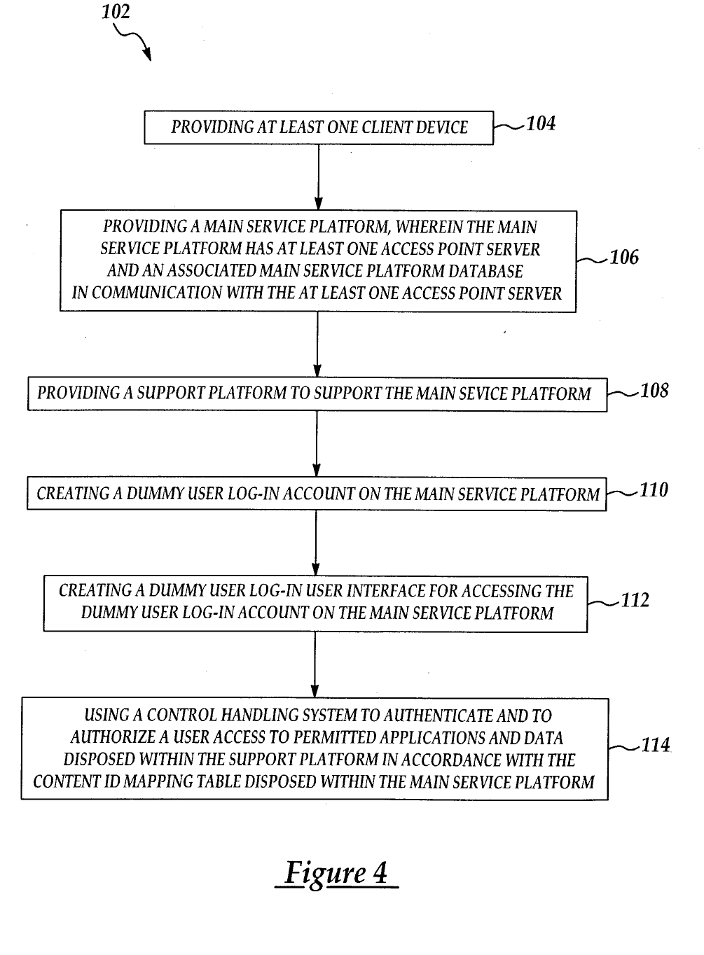

In accordance with another preferred embodiment of the present invention, as shown in FIG. 4, another method 102 is provided for using a multi-platform computer network. The method 102 having steps of:

providing at least one client device (step 104);

providing a main service platform, wherein the main service platform has at least one access point server and an associated main service platform database in communication with the at least one access point server (step 106), wherein the at main service platform is in operative communication with the at least one client device;

providing a support platform to support the main service platform (step 108), wherein the support platform has a support platform server and an associated support platform database in operative communication with the support platform server, the support platform in further operative communication with the main service platform;

creating a dummy user log-in account on the main service platform (step 110), wherein the dummy user log-in account has an associated dummy user identification representing a common user;

creating a dummy user log-in user interface for accessing the dummy user log-in account on the main service platform (step 112); and

using a control handling system to authenticate and to authorize a user access to permitted applications and data disposed within the support platform in accordance with the content ID mapping table disposed within the main service platform (step 114).

From the foregoing, it should be appreciated that a multi-platform computer network and method of simplifying access to the multi-platform computer network is provided.

While a preferred exemplary embodiment has been presented in the foregoing detailed description, it should be understood that a vast number of variations exist and this preferred exemplary embodiment is merely an example, and it is not intended to limit the scope, applicability or configuration of the invention in any way. Rather, the foregoing detailed description provides those of ordinary skill in the art with a convenient guide for implementing a preferred embodiment of the invention and various changes can be made in the function and arrangements of the exemplary embodiment without departing from the spirit and scope of the appended claims.

What is claimed is:

1. A multiple platform computer network comprising a:
at least one client device;
a main service platform, the main service platform in selective communication with the client device when the client device is properly authenticated and authorized for use with the main service platform;
a support platform for providing support to the main service platform;
a dummy log-in user interface for interfacing between the main service platform and the at least one client device; and
a control handling system for handling communications between the main service platform and the support platform.

2. The system of claim 1, wherein the multiple platform computer network further comprises a plurality of client devices in communication with the main server platform.

3. The system of claim 2, wherein the multiple platform computer network further comprises:
a communication conduit for communicating between the main service platform and the client device.

4. The system of claim 1, wherein the main service platform comprises:
at least one access point server; and
at least access point database, wherein the at least one access point server is in communication with the at least one access point database, and is in further communication with the at least one client device.

5. The system of claim 1, wherein the main service platform comprises:
a session server for monitoring and logging activities occurring within the multiple platform computer network.

6. The system of claim 5, wherein the support platform comprises:
at least one support platform server; and
at least one support platform database in operative communication with the at least one support platform server, and wherein the at least one support platform server is in operative communication with the main service platform.

7. The system of claim 1, wherein the dummy log-in user interface has a dummy account-password program disposed within the dummy log-in user interface for creating a dummy account to log into the main service platform, wherein the dummy account has an associated dummy user log-in ID.

8. The system of claim 7, wherein the dummy account-password program is executed using an automated script.

9. The system of claim 7, wherein the dummy account-password program is executed when a user manually enters in a dummy account and a dummy ID into the dummy log-in user interface.

10. The system of claim 9, wherein the multiple platform computer network further comprises:
a security layer for preventing unauthorized access to the multiple platform computer network.

11. A multiple platform computer network comprising a:
at least one client device;
a main service platform, the main service platform in selective communication with the client device when the client device is properly authenticated and authorized for use with the main service platform;
a support platform for providing support to the main service platform;
a dummy user log-in user interface for interfacing between the main service platform and the at least one client device; and
a content ID mapping table capable of associating each of a plurality of support platform user numbers with content accessible within the support platform; and
a control handling system for handling communications between the main service platform and the support platform.

12. The multiple platform computer network of claim 11, wherein the content ID mapping table comprises:
a plurality of cells forming
a first column for specifying permissible content for each of the plurality of support platform user numbers, and
a second column specifying each of the plurality of support platform user numbers associated with permissible content 64; and
a plurality of associated rows, wherein the number of the plurality of associated rows have an n total number of content associated with an m number of user numbers.

13. The multiple platform computer network of claim 12, wherein the content ID mapping table is disposed within the main service platform.

14. The multiple platform computer network of claim 11, wherein the control handling system comprises:
the support platform server to authenticate and authorize to access permitted applications and data disposed within the support platform in accordance with the content ID mapping table disposed within the main service platform.

15. A method for simplifying access to a multiple platform multiple platform computer network comprising the steps of:
a) providing a main service platform, wherein the main service platform has at least one access point server and an associated main service platform database in communication with the at least one access point server;
b) providing a support platform to support the main service platform, wherein the support platform has a support platform server and an associated support platform database in operative communication with the support platform server, the support platform in further operative communication with the main service platform;
c) creating a dummy user log-in account on the main service platform, wherein the dummy user log-in account has an associated dummy user identification representing a common user;
d) creating a dummy user log-in user interface for accessing the dummy user log-in account on the main service platform; and
e) providing a control handling system to handle communications between the main service platform and the support platform.

16. The method of claim 15 further comprising the steps of:
providing an identification (ID) table having a plurality of support platform user IDs; and
performing an ID maintenance function, wherein the ID maintenance function is selected from at least one of a support platform user ID creation function that operates to associate a support platform user ID with a client device, an update support platform user ID function that operates to modify a support platform user ID in accordance with an authorized system user's request, and a remove support platform user ID function that operates to remove a support platform user ID from the ID table.

17. The method of claim 16 further comprising the steps of:
associating the plurality of support platform user IDs disposed within the identification table with a plurality of associated support platform passwords to form a plurality of user numbers; and
storing the associated plurality of support platform user numbers within a user number table.

18. The method of claim 17, further comprising the step of:
mapping the plurality of user numbers stored within the user number table with associated permissible support platform content to form a content ID mapping table, wherein the content ID mapping table disposed within the main platform for associating permissible support platform content with a user number, and wherein the user number associates a user identification with an associated password.

19. The method of claim 18, further comprising the step of:
using a control handling system to authenticate and to authorize a user access to permitted applications and data disposed within the support platform in accordance with the content ID mapping table disposed within the main service platform.

20. A method of using a multi-platform computer network comprising the steps of:
providing at least one client device;
providing a main service platform, wherein the main service platform has at least one access point server and an associated main service platform database in communication with the at least one access point server, wherein the at main service platform is in operative communication with the at least one client device;
providing a support platform to support the main service platform, wherein the support platform has a support platform server and an associated support platform database in operative communication with the support platform server, the support platform in further operative communication with the main service platform;
creating a dummy user log-in account on the main service platform, wherein the dummy user log-in account has an associated dummy user identification representing a common user;
creating a dummy user log-in user interface for accessing the dummy user log-in account on the main service platform; and
using a control handling system to authenticate and to authorize a user access to permitted applications and data disposed within the support platform in accordance with the content ID mapping table disposed within the main service platform.
